(19) United States
(12) Patent Application Publication
(10) Pub. No.: US 2026/0320865 A1
(43) Pub. Date: Oct. 15, 2026

(54) SYSTEM AND METHOD FOR OBJECT INSERTION IN IMAGE

(71) Applicant: SAMSUNG ELECTRONICS CO., LTD., Suwon-si (KR)

(72) Inventors: Shashi Kumar PARWANI, Bengaluru (IN); Praful MATHUR, Ajmer (IN); Roopa Sheshadri KOTIGANAHALLY, Bengaluru (IN)

(73) Assignee: SAMSUNG ELECTRONICS CO., LTD., Suwon-si (KR)

(21) Appl. No.: 19/464,037

(22) Filed: Jan. 29, 2026

Related U.S. Application Data
(63) Continuation of application No. PCT/KR2024/011982, filed on Aug. 12, 2024.

(30) Foreign Application Priority Data
Aug. 12, 2024 (IN) 202341054286
Aug. 12, 2024 (IN) 202341054286

(51) Int. Cl. G06T 11/60; G06T 7/11; G06T 7/136; G06T 7/50; G06T 7/70; G06T 7/90; G06T 11/23

(52) U.S. Cl. CPC G06T 11/60; G06T 7/11; G06T 7/136; G06T 7/50; G06T 7/70; G06T 7/90; G06T 11/23; G06T 2207/20084; G06T 2210/12

(57) ABSTRACT

A method for object insertion in an image, includes detecting a stroke input indicating a request to insert one or more objects in the image; identifying a shape and a color of the stroke input; generating, using an artificial intelligence (AI) model, a plurality of first candidate objects based on the identified shape and the color of the stroke; selecting one or more second candidate objects among the plurality of first candidate objects based on the context of the scene and the location of the stroke input; and updating the image by inserting the one or more second candidate objects based on the depth information and the location of the stroke input.

### CROSS-REFERENCE TO RELATED APPLICATIONS

This application is a Bypass Continuation Application of International Application PCT/KR2024/011982, filed on Aug. 12, 2024, which claims priority to Indian Patent Application number 202341054286, filed on Jun. 28, 2024, in the Indian Intellectual Property Office, and Indian Provisional Patent Application No. 202341054286, filed on Aug. 12, 2023, in the Indian Intellectual Property Office, the disclosures of which are incorporated by reference herein in their entireties.

### BACKGROUND

### 1. Field

The present disclosure relates to image generation using generative artificial intelligence (AI) and more particularly, to a system and method for an object insertion in an image.

### 2. Description of Related Art

Recent developments in generative AI have facilitated the use of diffusion models to generate highly realistic images from minimal input data. Diffusion models have emerged as a potent member within the family of deep generative models, proving to be a valuable tool in the domains of image manipulation and object addition, due to their capacity to produce highly realistic outputs. A diverse range of guided generative techniques have been proposed, focusing on generating images from scratch or on the global manipulation of existing images.

However, when generating images from text inputs, these diffusion models struggle to adequately capture essential attributes, such as, color, depth, and other properties of the intended object. While generative models like sketch-to-image can provide spatial information to the model, the output does not always adhere to the user-drawn strokes and the context within the image. Typically, it is exceedingly challenging to instruct a model about the precise location to generate an object in an image via a text prompt or doodle solution, which can guide the generation process. This guidance enables users to convey their intent in natural ways; however, providing this spatial guidance is often not sufficient. The generation of an image from text guidance fails to reliably provide properties like the color of the object to be generated. Additionally, this also leads to missing appearance details in a user's stroke, missing context of the image, and incorrect placement of the generated object. Even additional prompts, such as masks, are not enough to provide exact localization information, such as depth. Therefore, this increases the difficulty of guiding these models to focus on adding or replacing an object in the image locally. Currently, there is no existing solution capable of generating an object within an image while accurately incorporating stroke colors, sizes, and the contextual information present within the image.

FIG. 1A illustrates an exemplary scenario of a text-to-image generative model, in accordance with the related art. In the text-to-image generative model, the guided generation of an object using only text prompts is difficult. Further, a definition of positional or depth information is also difficult to establish using text prompts. Therefore, the text-to-image generative model is not able to generate a realistic-looking object using mere text description.

FIG. 1B illustrates an exemplary scenario of a scribble diffusion generative model, in accordance with the related art. In the scribble diffusion generative model, providing color information via simple strokes is difficult. Further, the scribble diffusion generative model fails to fully understand spatial properties intended for the generated objects. Thus, it is difficult to generate a plurality of objects that have never been established in the scribble diffusion generative model. In particular, the scribble diffusion generative model fails to consider any type of depth-related information. A new object cannot be created on an existing image, and the scribble diffusion generative model can only function on a blank canvas. Moreover, color and texture information cannot be controlled by the use of plain black strokes in the scribble diffusion generative model.

FIG. 1C illustrates an exemplary scenario of a Paint2Pix generative model, in accordance with the related art. The Paint2Pix generative model can generate objects for limited classes on which the Paint2Pix generative model is trained. Further, the Paint2Pix generative model can generate an object on a blank canvas but cannot be used to generate a new object on an existing image. Also, the Paint2Pix generative model has limited mapping of strokes to image parts.

Further, the additional problems associated with the related art generative models are discussed below:

One of the most common issues faced by image generation models is object hallucination. This issue occurs when shadow artifacts generate hallucinations in images. These hallucinations can be fictitious, unusual, and vaguely shaped objects, caused by multiple factors like artifacts (shadows, reflections, etc.) or unclear prompts. Also, due to their fundamental structure, content from image generation models can be difficult to match users' expectations and difficult to reproduce consistently.

Some related art generative models fail to provide appearance details like the shape and color of the object to be generated via text prompts or plain strokes.

Some related art generative models fail to employ any mechanism to understand the image context. Context information helps determine appropriate object for generation.

Some related art generative models may have an occlusion problem when the strokes are drawn on top of another object.

Some related art generative models may generate immodest/foul objects.

Existing doodle solutions deploy a simple method to draw anything on an image, with potentially generation. But these solutions have a limitation that they can draw only on top of an image. If these solutions have to place an object at some depth, manual adjustments are required. conventional image generative models tend to add/replace objects always on top of an image. It is difficult for generative models to identify and place the object in the background. Force prompting like “generate in the background” alters the context of the image by removing existing foreground objects in the image.

Therefore, in view of the above-mentioned problems, it is advantageous to provide an improved system and method that can overcome the above-mentioned problems and limitations associated with object generation on an existing image.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to an aspect of the disclosure, a method for object insertion in an image, includes: detecting a stroke input indicating a request to insert one or more objects in the image; identifying a shape and a color of the stroke input; generating, using an artificial intelligence (AI) model, a plurality of first candidate objects based on the shape and the color of the stroke input; determining depth information of the one or more objects to be inserted in the image based on a position of the stroke input and one or more neighboring objects within the image; identifying a context of a scene of the image; identifying a location of the stroke input within the image; selecting one or more second candidate objects among the plurality of first candidate objects based on the context of the scene and the location of the stroke input; and updating the image by inserting the one or more second candidate objects based on the depth information and the location of the stroke input.

The identifying the location of the stroke input within the image may include: identifying a size of the stroke input; identifying a bounded region within the image based on the size of the stroke input; and identifying the location of the stroke input within the image based on the bounded region.

The determining the depth information of the one or more objects to be inserted in the image may include: determining a depth map based on the image, and determining the position of the stroke input.

The updating the image may include: generating a binary mask of the image based on the bounded region; and inserting at least one of the one or more second candidate objects based on the binary mask and depth information.

The generating the plurality of first candidate objects may include: extracting, using a low-pass filter, color-based features of the stroke input; generating a color feature map corresponding to the stroke input based on the color-based features and one or more predefined color-related parameters; extracting, using a high-pass filter, shape-based features of the stroke input; generating a shape feature map corresponding to the stroke input based on the shape-based features and one or more predefined shape-related parameters; and generating, using a diffusion model, the plurality of first candidate objects based at least on the color feature map, the shape feature map, and a plurality of random noises.

The selecting the one or more second candidate objects among the plurality of first candidate objects may include: determining correlation scores associated with the plurality of first candidate objects based on the context of the scene and the location of the stroke input; and selecting the one or more second candidate objects among the plurality of first candidate objects based on the correlation scores.

The updating the image with the one or more second candidate objects may include: determining a depth map of the image based at least on the depth information of the one or more objects to be inserted in the image and at least one reference object within the image; determining a depth of each of the one or more second candidate objects; determining a similarity and a proximity of each of the one or more second candidate objects based on the depth of each of the one or more second candidate objects and the depth map of the image; and filtering at least one of the one or more second candidate objects based on the similarity and the proximity of each of the one or more second candidate objects.

According to an aspect of the disclosure, a device for object insertion in an image, includes: a memory configured to store at least one instruction; and at least one processor operatively coupled with the memory, wherein the at least one instruction, when executed by the at least one processor individually or collectively, causes the device to: detect a stroke input indicating a request to insert one or more object in the image; identify a shape and a color of the stroke input; generate, using an artificial intelligence (AI) model, a plurality of first candidate objects based on the shape and the color of the stroke input; determine depth information of the one or more objects to be inserted in the image based on a position of the stroke input and one or more neighboring objects within the image; identify a context of a scene of the image; identify a location of the stroke input within the image; select one or more second candidate objects among the plurality of first candidate objects based on the context of the scene and the location of the stroke input; and update image by inserting the one or more second candidate objects based on the depth information and the location of the stroke input.

The at least one instruction, when executed by the at least one processor individually or collectively, may cause the device to identify the location of the stroke input within the image by: identifying a size of the stroke input; identifying a bounded region within the image based on the size of the stroke input; and identifying the location of the stroke input within the image based on the bounded region.

The at least one instruction, when executed by the at least one processor individually or collectively, may cause the device to determine the depth information of the one or more objects to be inserted in the image by: determining a depth map based on the image, and determining the position of the stroke input.

The at least one instruction, when executed by the at least one processor individually or collectively, may cause the device to update the image by: generating a binary mask on the image based on the bounded region; and inserting at least one of the one or more second candidate objects based on the binary mask and depth information.

The at least one instruction, when executed by the at least one processor individually or collectively, may cause the device to generate the plurality of first candidate objects by: extracting, using a low-pass filter, color-based features of the stroke input; generating a color feature map corresponding to the stroke input based on the color-based features and one or more predefined color-related parameters; extracting, using a high-pass filter, shape-based features of the stroke input; generating a shape feature map corresponding to the stroke input based on the shape-based features and one or more predefined shape-related parameters; and generating, using a diffusion model, the plurality of first candidate objects based at least on the color feature map, the shape feature map, and a plurality of random noises.

The at least one instruction, when executed by the at least one processor individually or collectively, may cause the device to select the one or more second candidate objects among the plurality of first candidate objects, the at least one processor by: determining correlation scores associated with the plurality of first candidate objects based on the context of the scene and the location of the stroke input; and selecting the one or more second candidate objects among the plurality of first candidate objects based on the correlation scores.

The at least one instruction, when executed by the at least one processor individually or collectively, may cause the device to update the image with the one or more second candidate objects by: determining a depth map of the image based at least on the depth information of the one or more objects to be inserted in the image and at least one reference object within the image; determining a depth of each of the one or more second candidate objects; determining a similarity and a proximity of each of the one or more second candidate objects based on the depth of each of the one or more second candidate objects and the depth map of the image; and filtering at least one of the one or more second candidate objects based on the similarity and the proximity of each of the one or more second candidate objects.

According to an aspect of the disclosure, a non-transitory computer-readable recording medium has recorded thereon instructions executable by at least one processor configured to perform a method for image encoding, the method including: detecting a stroke input indicating a request to insert one or more objects in the image; identifying a shape and a color of the stroke input; generating, using an artificial intelligence (AI) model, a plurality of first candidate objects based on the shape and the color of the stroke input; determining depth information of the one or more objects to be inserted in the image based on a position of the stroke input and one or more neighboring objects within the image; identifying a context of a scene of the image; identifying a location of the stroke input within the image; selecting one or more second candidate objects among the plurality of first candidate objects based on the context of the scene and the location of the stroke input; and updating the image by inserting the one or more second candidate objects based on the depth information and the location of the stroke input.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates an exemplary scenario of a text-to-image generative model, in accordance with the related art;

FIG. 1B illustrates an exemplary scenario of a scribble diffusion generative model, in accordance with the related art;

FIG. 1C illustrates an exemplary scenario of a Paint2Pix generative model, in accordance with the related art;

FIG. 2 illustrates an environment of a system communicably coupled with a device, in accordance with an embodiment of the present disclosure;

FIG. 3 illustrates a block diagram of the system in connection with the device for Doodle Assisted Context Aware Object Generation (DACAOG), in accordance with an embodiment of the present disclosure;

FIG. 4 illustrates a sequential process for inserting an object in an image, in accordance with an embodiment of the present disclosure;

FIG. 5 illustrates an extraction of doodle strokes from an image, in accordance with an embodiment of the present disclosure;

FIG. 6 illustrates a training paradigm of a doodle-to-object diffusion model, in accordance with an embodiment of the present disclosure;

FIG. 7 a training paradigm of stroke-guided loss of the system, in accordance with an embodiment of the present disclosure;

FIG. 8 illustrates a training paradigm of color-guided loss of the system, in accordance with an embodiment of the present disclosure;

FIG. 9 illustrates a color extractor and a shape extractor of the system, in accordance with an embodiment of the present disclosure;

FIG. 10 illustrates a determination of a bounding region and a binary mask, in accordance with an embodiment of the present disclosure;

FIG. 11A illustrates a selection of one or more second candidate objects by a contrastive scene-object-position mapping model, in accordance with an embodiment of the present disclosure;

FIG. 11B illustrates a training paradigm of the contrastive scene-object-position mapping model, in accordance with an embodiment of the present disclosure;

FIG. 11C illustrates a plurality of examples associated with the contrastive scene-object-position mapping model, in accordance with an embodiment of the present disclosure;

FIG. 11D illustrates an operation of the contrastive scene-object-position mapping model, in accordance with an embodiment of the present disclosure;

FIG. 12A illustrates a depth estimation method for a plurality of objects which are candidates for depth estimation, in accordance with an embodiment of the present disclosure;

FIG. 12B illustrates a detailed explanation of the depth estimation method, in accordance with an embodiment of the present disclosure;

FIG. 12C illustrates a flowchart for depth based object selection module in the depth estimation method, in accordance with an embodiment of the present disclosure;

FIG. 12D illustrates the same depth, same size object in depth based object selection module in the depth estimation method, in accordance with an embodiment of the present disclosure;

FIG. 12E illustrates the same depth, small-size object in depth depth-based object selection module in the depth estimation method, in accordance with an embodiment of the present disclosure;

FIG. 12F illustrates same depth, multiple-sized object in depth based object selection module in the depth estimation method, in accordance with an embodiment of the present disclosure;

FIG. 12G illustrates a ScaleRef Network in the depth estimation method, in accordance with an embodiment of the present disclosure;

FIG. 12H illustrates a plurality of examples for the ScaleRef Network in the depth estimation method, in accordance with an embodiment of the present disclosure;

FIG. 13 illustrates an operation of an object image synthesizer of the system, in accordance with an embodiment of the present disclosure;

FIGS. 14A and 14B illustrate a use case of the system, in accordance with an embodiment of the present disclosure; and

FIG. 15 illustrates a flowchart of a method for inserting the object in the image, in accordance with an embodiment of the present disclosure.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

In the drawings, like reference numerals refer to like elements.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, “includes”, “including” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

Embodiments of the present disclosure will be described below in detail with reference to the accompanying drawings.

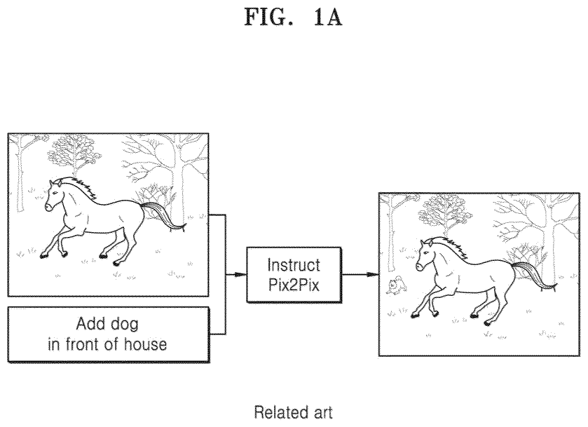

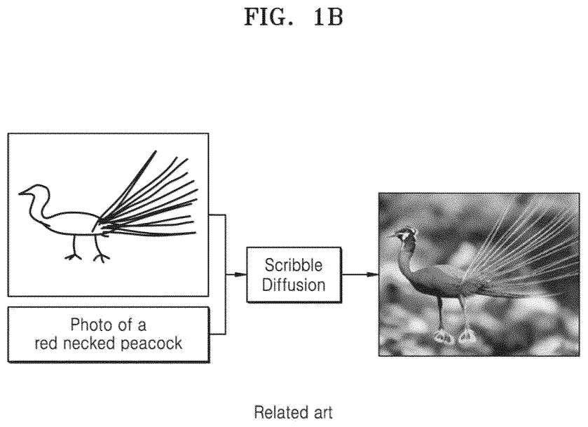

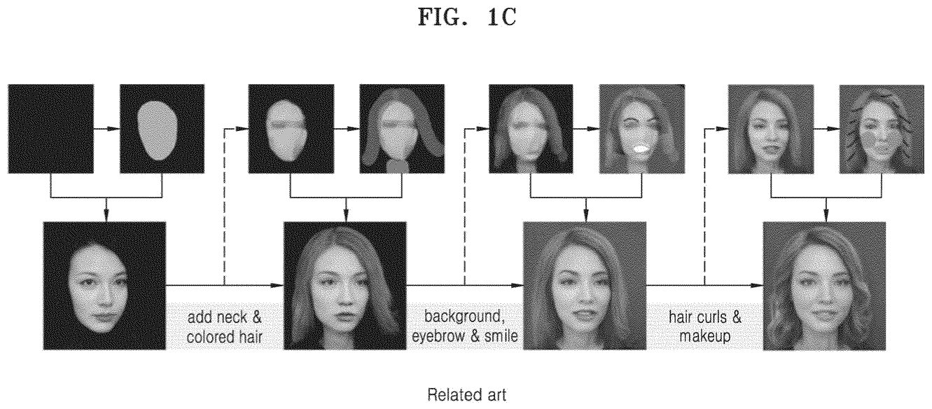

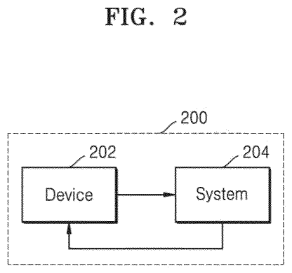

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

The present disclosure relates to a Doodle Assisted Context Aware Object Generation (DACAOG) method, may be used for generation of an object in an image using generative artificial intelligence (AI). The DACAOG method may be used for generating a new object from a scribble on an existing image and places the generated object appropriately in the image by determining depth information from a 2D image and correlating the image and present object. The DACAOG method may be a contrastive object-to-image mapping model using which objects are further filtered. Furthermore, user-drawn strokes may be used to define the appearance properties of the generated object.

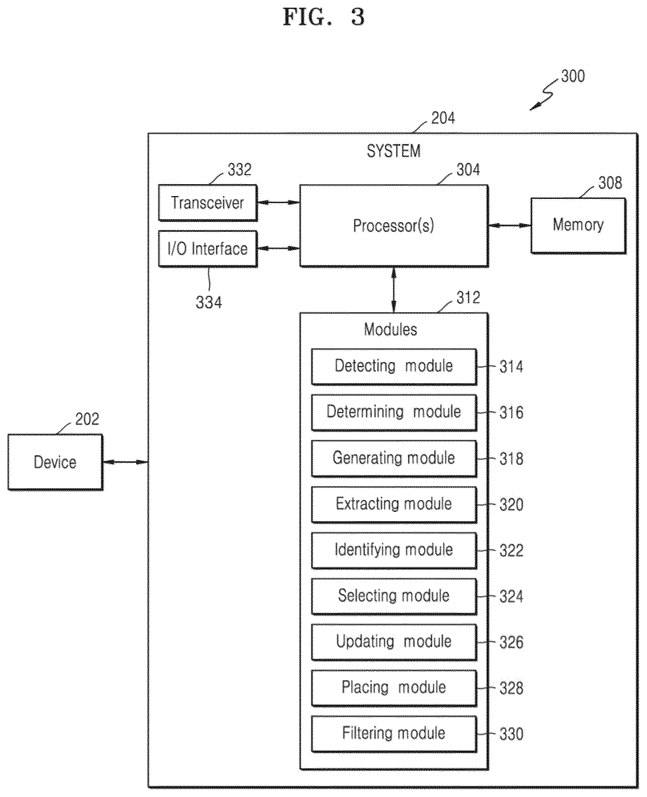

FIG. 2 illustrates an environment 200 comprising a system 204 communicably coupled with a device 202, in accordance with an embodiment of the present disclosure. FIG. 3 illustrates a block diagram 300 of the system 204 in connection with the device 202 for DACAOG), in accordance with an embodiment of the present disclosure.

In an embodiment, the device 202 may be a smartphone, a tablet, or any other electronic device compatible with capturing/searching images, etc.

When the image is searched/captured by the device 202, and a user wants to insert any object in the searched/captured image, then the system 204 may be configured to insert the object based on one or more user inputs in form user strokes drawn on the image. The system 204 may be configured to insert the object based on different factors, which may include but is not limited to, detecting a stroke input, shape and color of stroke input, etc. The constructional and operational details of the system 204 are explained in the subsequent paragraphs.

In an embodiment, the system 204 may be deployed in the device 202. In another embodiment, the system 204 may be communicatively coupled with the device 202.

In an embodiment, the system 204 may include, but is not limited to, at least one processor (referred to here as one or more processor, a processor) 304, a memory 308, and a plurality of modules 312 among other examples which are explained in detail in the subsequent paragraphs.

The system 204 may include an Input/Output (I/O) interface 334 and a transceiver 332. Further, in some embodiments where the system 204 is implemented as a standalone entity at a server/cloud architecture, the system 204 may be in communication with multiple devices to receive data from each device. Further, the details provided below with respect to the system 204 and the device 202 are applicable for the system 204 and the multiple devices as well.

In an embodiment, the processor 304 may be operatively coupled to each of the I/O interface 334, the plurality of modules 312, the transceiver 332, and the memory 308 . . . . In one embodiment, the processor 304 may include at least one data processor for executing processes in a virtual storage area network. The processor 304 may include specialized processing units such as integrated system (bus) controllers, memory management control units, floating point units, graphics processing units, digital signal processing units, etc. In one embodiment, the processor 304 may include a central processing unit (CPU), a graphics processing unit (GPU), or both. The processor 304 may be one or more general processors, digital signal processors, application-specific integrated circuits, field-programmable gate arrays, servers, networks, digital circuits, analog circuits, combinations thereof, or other now-known or later developed devices for analyzing and processing data. The processor 304 may execute a software program, such as code generated manually (i.e., programmed) to perform the desired operation.

The processor 304 may be disposed in communication with one or more input/output (I/O) devices via the I/O interface 334. In some embodiments, the processor 304 may communicate with the device 202 using the I/O interface 334. In some embodiments, the I/O interface 334 may be implemented within the device 202. In an embodiment, the I/O interface 334 may enable input and output to and from the system 204 using suitable devices such as, but not limited to, camera, display, and so forth.

Using the I/O interface 334, the system 204 may communicate with one or more I/O devices, specifically, the device 202, in which the system 204 inserts the object in the image as per requirement of the user. For example, the input device may be an antenna, microphone, touch screen, touchpad, storage device, transceiver, recording device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 304 may be disposed in communication with a communication network via a network interface. In an embodiment, the network interface may be the I/O interface 334. The network interface may connect to the communication network to enable the connection of the system 204 with the device 202. The network interface may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 204 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 702.11a/b/g/n/x, etc.

The transceiver 332 may be configured to receive and/or transmit signals to and from the device 202. In one embodiment, the database may be configured to store the information as required by the plurality of modules 312 and the processor 304 to insert the object in the image.

In some embodiments, the memory 308 may be communicatively coupled to the processor 304. The memory 308 may be configured to store data, and instructions executable by the processor 304. In one embodiment, the memory 308 may be provided within the device 202. In another embodiment, the memory 308 may be provided within the system 204 being remote from the device 202. In yet another embodiment, the memory 308 may communicate with the processor 304 via a bus within the system 204. In yet another embodiment, the memory 308 may be located remote from the processor 304 and may be in communication with the processor 304 via a network. The memory 308 may include but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 308 may include a cache or random-access memory for the processor 304. In alternative examples, the memory 308 is separate from the processor 304, such as a cache memory of a processor, the system memory, or other memory. The memory 308 may be an external storage device or database for storing data. The memory 308 may be operable to store instructions executable by the processor 304. The functions, acts, or tasks illustrated in the figures or described may be performed by the programmed processor 304 for executing the instructions stored in the memory 308. The functions, acts, or tasks may be independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

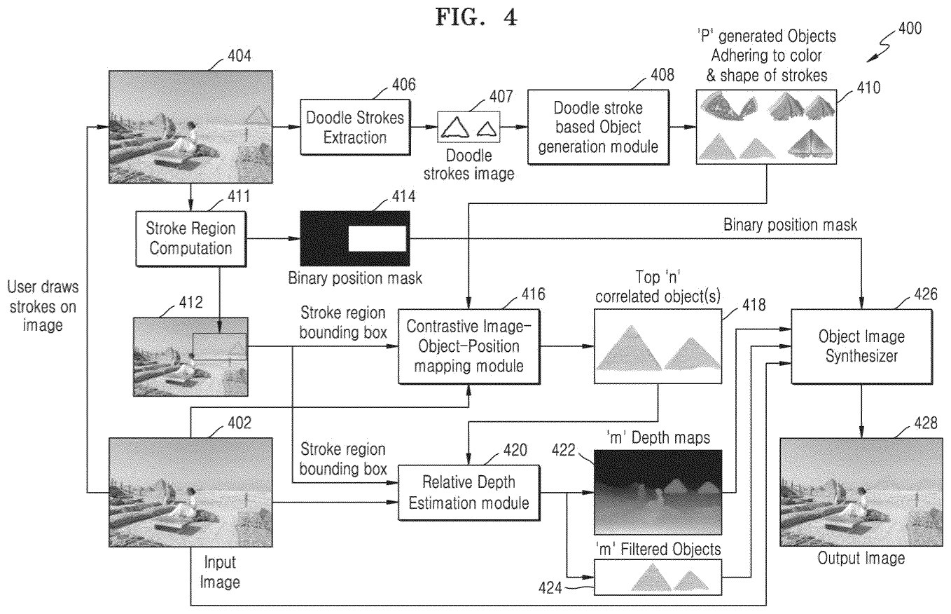

In some embodiments, the plurality of modules 312 may be included within the memory 308. The memory 308 may further include a database to store data. The plurality of modules 312 may include a set of instructions that may be executed to cause the system 204, in particular, the processor 304 of the system 204, to perform any one or more of the methods/processes disclosed herein. The plurality of modules 312 may be configured to perform the steps of the present disclosure using the data stored in the database. For instance, the plurality of modules 312 may be configured to perform the steps disclosed in FIGS. 4 to 13.

In an embodiment, each of the plurality of modules 312 may be a hardware unit that may be outside the memory 308. Further, the memory 308 may include an operating system for performing one or more tasks of the system 204, as performed by a generic operating system.

In one example, the modules 312 may include a detecting module 314, a determining module 316, a generating module 318, an extracting module 320, an identifying module 322, a selecting module 324, an updating module 326, a placing module 328, and a filtering module 330. Each of the detecting module 314, the determining module 316, the generating module 318, the extracting module 320, the identifying module 322, the selecting module 324, the updating module 326, the placing module 328, and the filtering module 330 may be in communication with each other. Further, each of the detecting module 314, the determining module 316, the generating module 318, the extracting module 320, the identifying module 322, the selecting module 324, the updating module 326, the placing module 328, and the filtering module 330 may be in communication with the processor 304.

Further, the present disclosure also contemplates a computer-program product that includes instructions or receives and executes instructions responsive to a propagated signal. Further, the instructions are transmitted or received over the network via a communication port or interface or using a bus. The communication port or interface may be a part of the processor 304 or may be a separate component. The communication port may be created in software or may be a physical connection in hardware. The communication port may be configured to connect with the network, external media, the display, or any other components in the system 204. The connection with the network may be a physical connection, such as a wired ethernet connection, or may be established wirelessly. Likewise, the additional connections with other components of the system 204 may be physical or may be established wirelessly. The network may alternatively be directly connected to the bus. For the sake of brevity, the architecture, and standard operations of the memory 308 and the processor 304 are not discussed in detail.

In an embodiment, the computer-program product, having machine-readable instructions stored therein, when executed by the processor 304, causes the processor 304 to perform a method inserting the object in the image. The details on the method(s) performed by the processor 304 have been elaborated in subsequent paragraphs at least with reference to FIGS. 4-13 in conjunction with FIG. 3.

Further, the present disclosure also contemplates a non-transitory computer-readable medium encoded with executable instructions. The executable instructions, when executed by the processor 304, cause the processor 304 to perform a method for inserting the object in the image. The details on the method(s) performed by the processor 304 have been elaborated in subsequent paragraphs at least with reference to FIGS. 4-13 in conjunction with FIG. 3. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

The processor 304, in conjunction with the detecting module 314, the determining module 316, the generating module 318, the extracting module 320, the identifying module 322, the selecting module 324, the updating module 326, the placing module 328, and the filtering module 330 may be configured to perform specific operations explained in subsequent paragraphs.

In some embodiments, one module may be implemented as multiple modules, and the functions of multiple modules may also be implemented by the same module. These modules may be located in the same device or in different devices. In some embodiments, a device may include one or more of modules 314-330.

Hardware modules in the various implementations may be implemented mechanically or electronically. For example, a hardware module may include a specially designed permanent circuit or logic device (e.g., a dedicated processor such as an field-programmable gate arrays (FPGA) or an application-specific integrated circuits (ASIC)) to perform a particular operation. The hardware module may also include a programmable logic device or circuit (e.g., including a general-purpose processor or other programmable processors) temporarily configured by software to perform a specific operation. As for the specific implementation of the hardware modules by a mechanical mean, or by a dedicated permanent circuit, or by a temporarily configured circuit (e.g., configured by software), it can be determined based on the consideration of cost and time.

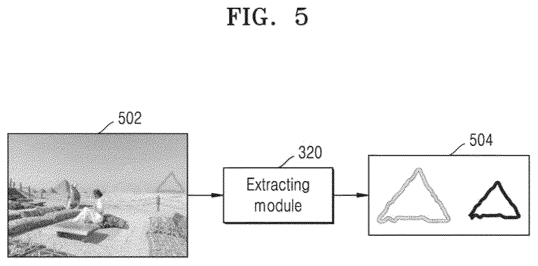

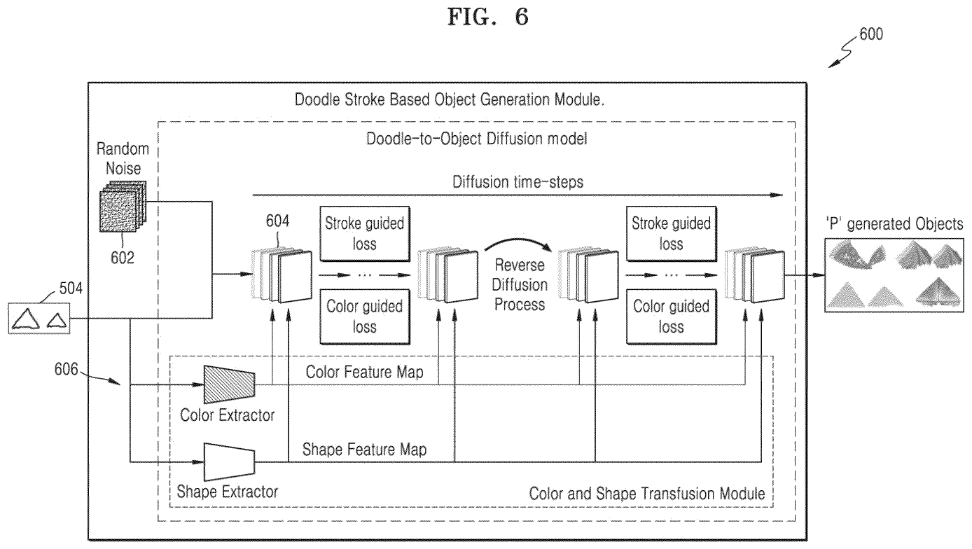

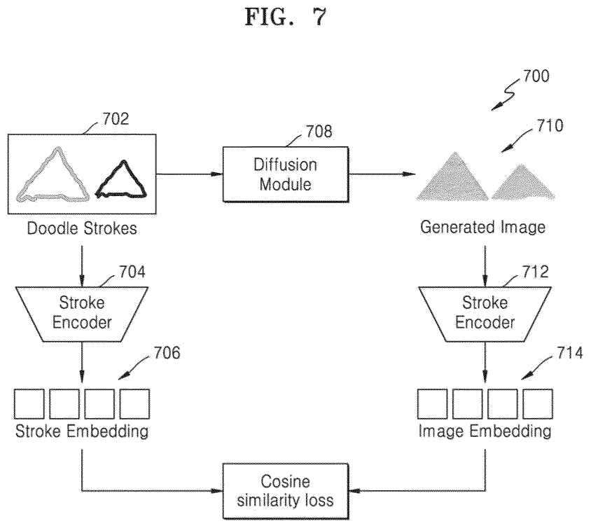

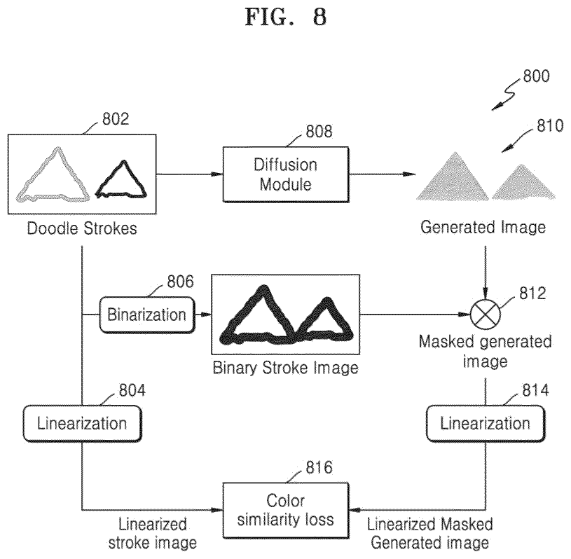

FIG. 4 illustrates a sequential process for inserting an object in an image, in accordance with an embodiment of the present disclosure. FIG. 5 illustrates an extraction of doodle strokes 504 from the image, in accordance with an embodiment of the present disclosure. FIG. 6 illustrates a training paradigm of the doodle-to-object diffusion model of the system 204, in accordance with an embodiment of the present disclosure. FIG. 7 illustrates a training paradigm of stroke-guided loss of the system 204, in accordance with an embodiment of the present disclosure. FIG. 8 illustrates a training paradigm of color-guided loss of the system 204, in accordance with an embodiment of the present disclosure.

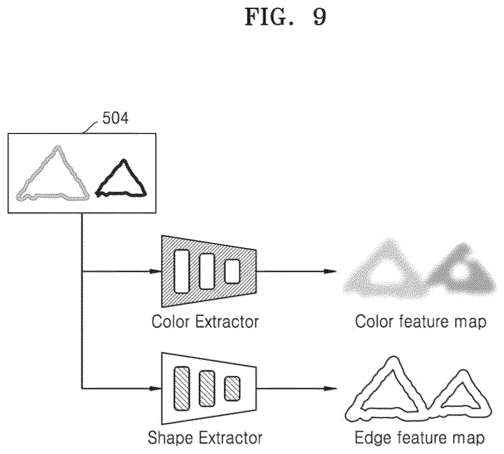

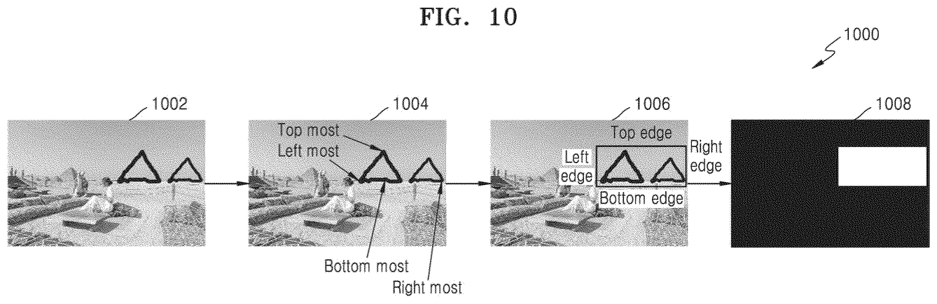

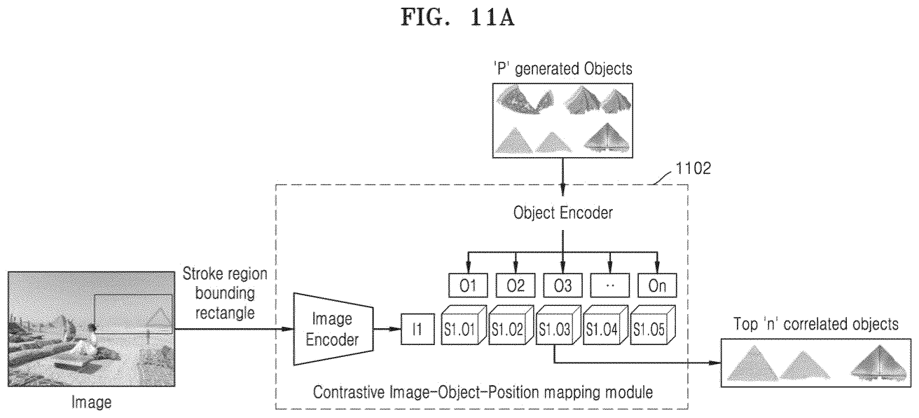

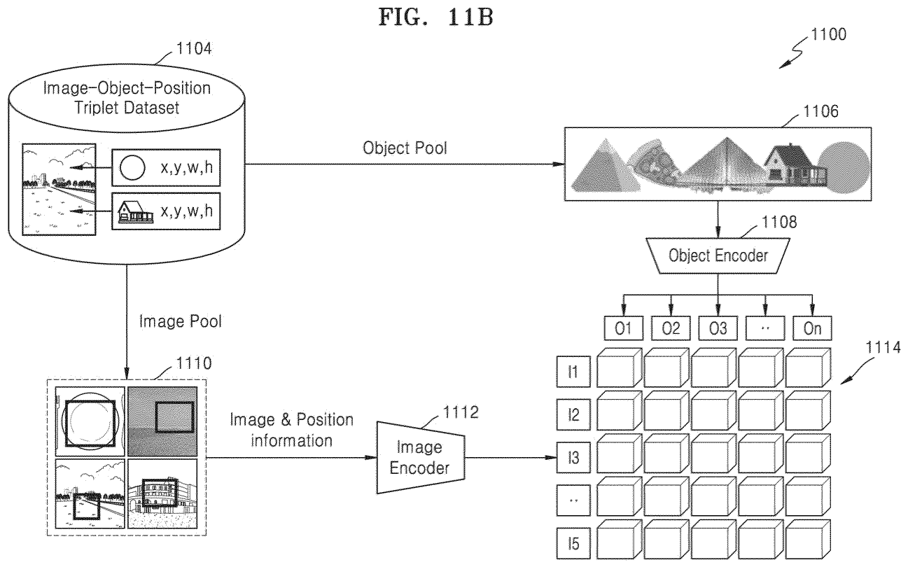

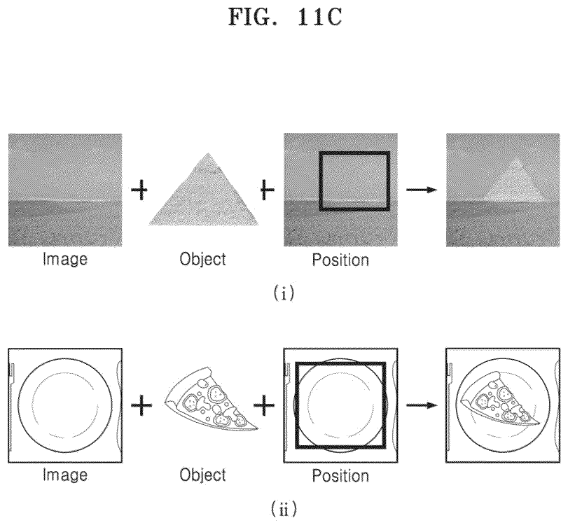

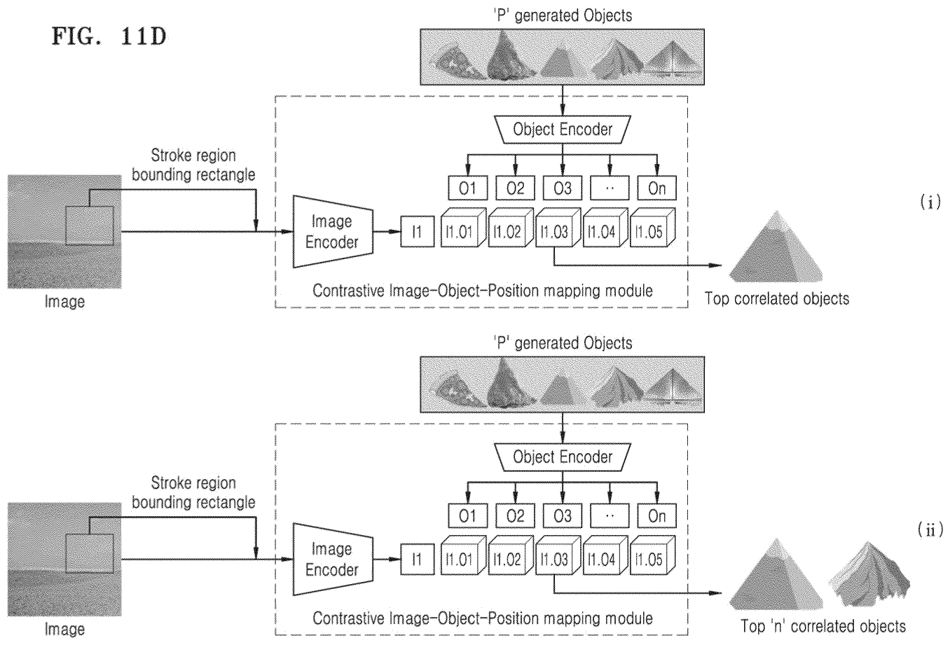

FIG. 9 illustrates a color extractor and a shape extractor of the system 204, in accordance with an embodiment of the present disclosure. FIG. 10 illustrates a determination of a bounding region and a binary mask, in accordance with an embodiment of the present disclosure. FIG. 11A illustrates a selection of one or more second candidate objects by a contrastive scene-object-position mapping model 1102, in accordance with an embodiment of the present disclosure. FIG. 11B illustrates a training paradigm of the contrastive scene-object-position mapping model 1102, in accordance with an embodiment of the present disclosure. FIG. 11C illustrates a plurality of examples associated with the contrastive scene-object-position mapping model 1102, in accordance with an embodiment of the present disclosure. FIG. 11D illustrates an operation of the contrastive scene-object-position mapping model 1102, in accordance with an embodiment of the present disclosure.

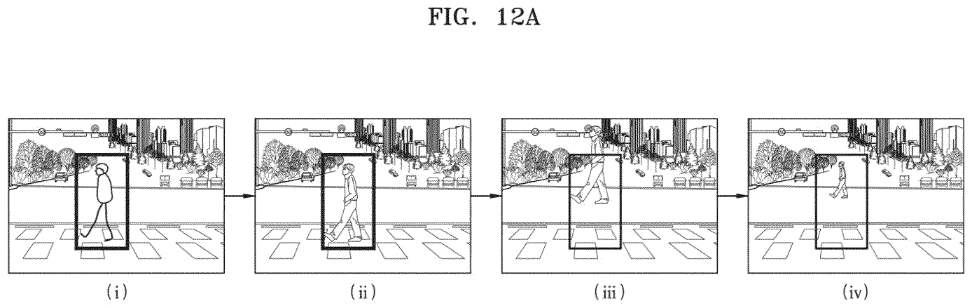

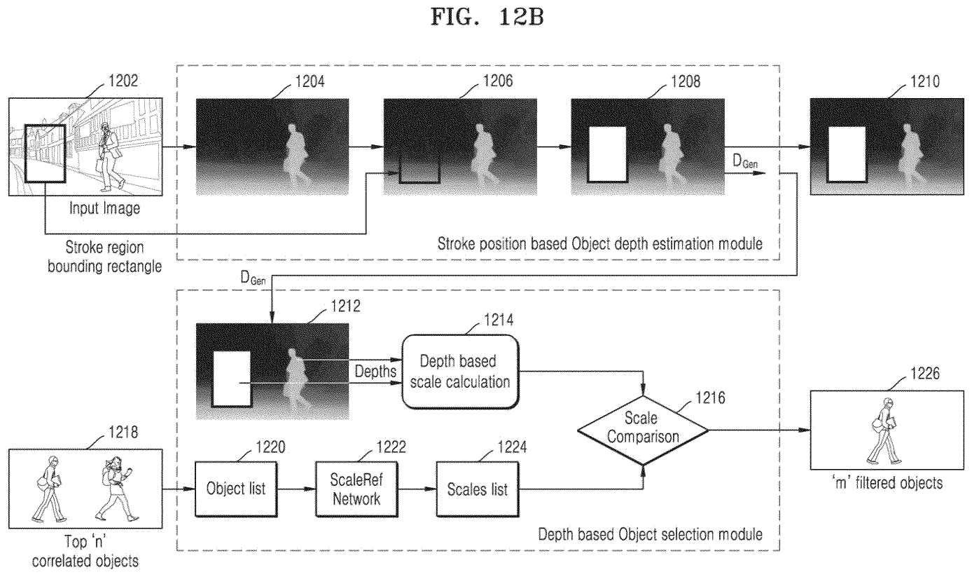

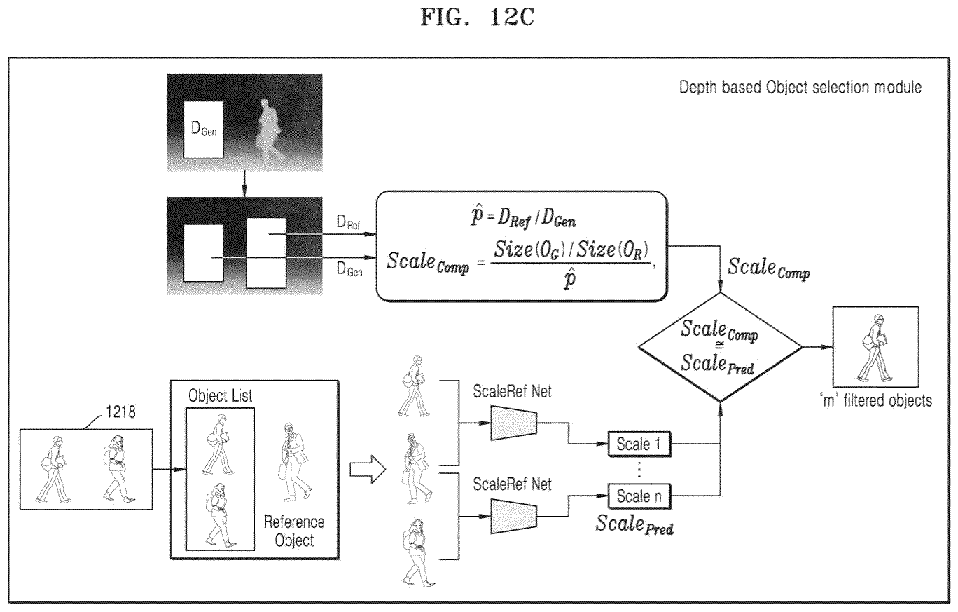

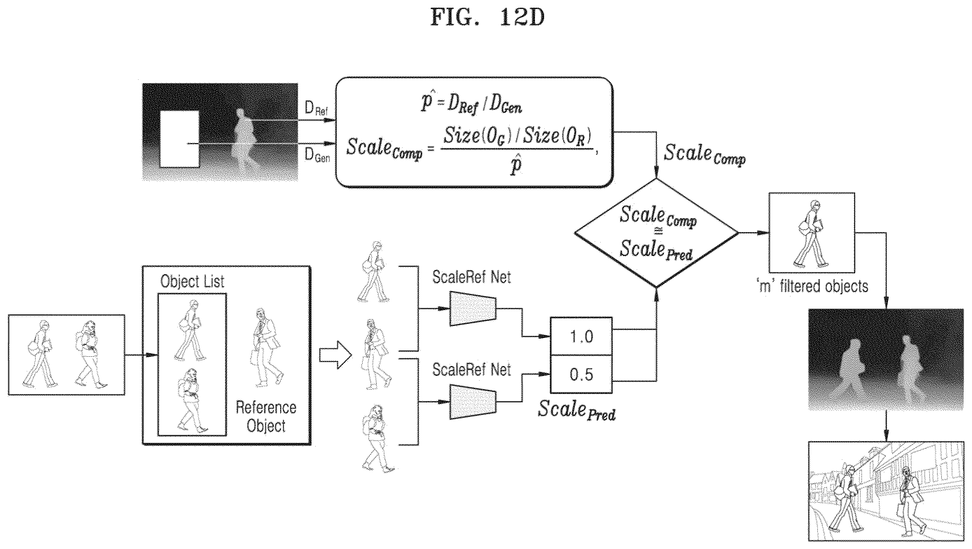

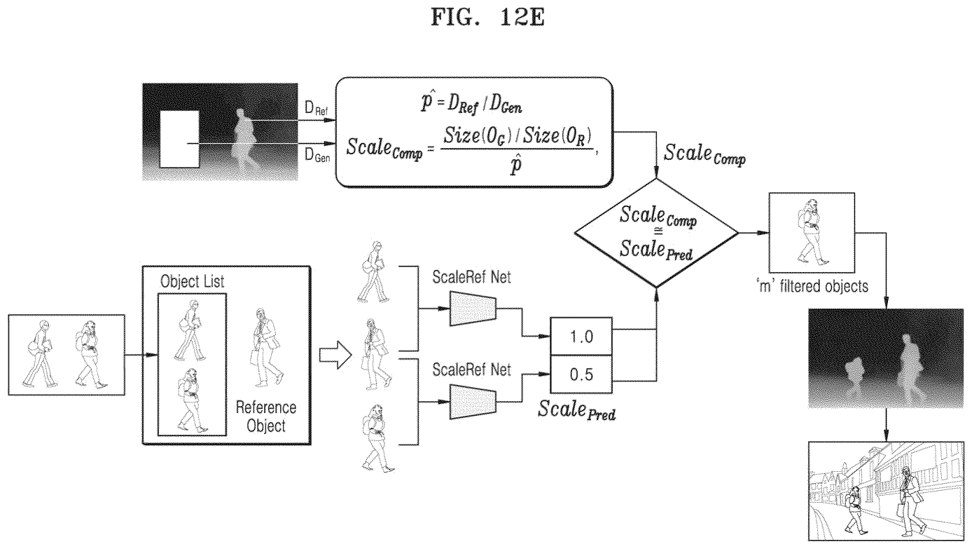

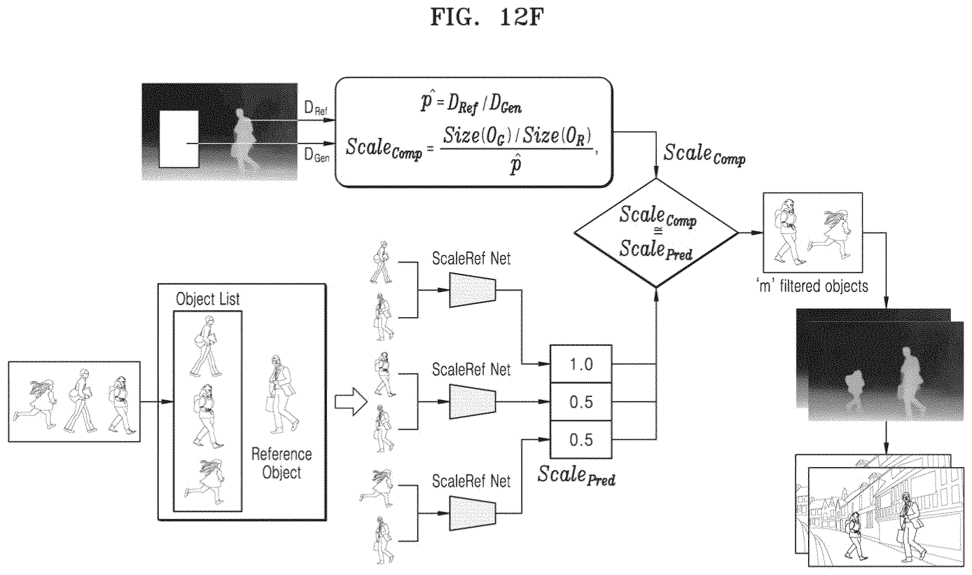

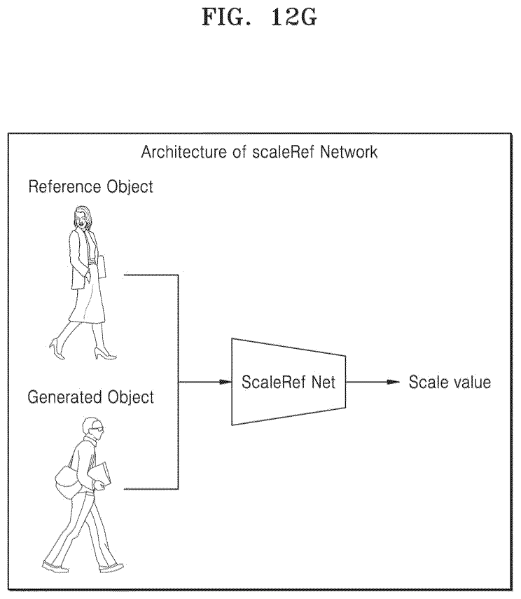

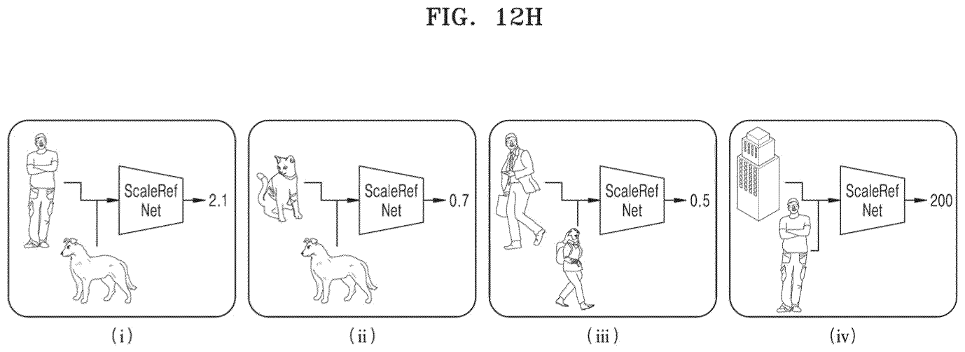

FIG. 12A illustrates a depth estimation method for a plurality of objects which are candidates for depth estimation, in accordance with an embodiment of the present disclosure. FIG. 12B illustrates a detailed explanation of the depth estimation method, in accordance with an embodiment of the present disclosure. FIG. 12C illustrates a flowchart for a depth-based object selection module in the depth estimation method, in accordance with an embodiment of the present disclosure. FIG. 12D illustrates the same depth, same size object in depth depth-based object selection module in the depth estimation method, in accordance with an embodiment of the present disclosure. FIG. 12E illustrates the same depth, small-size object in depth depth-based object selection module in the depth estimation method, in accordance with an embodiment of the present disclosure. FIG. 12F illustrates the same depth, multiple small-sized object in depth based object selection module in the depth estimation method, in accordance with an embodiment of the present disclosure. FIG. 12G illustrates a ScaleRef Network in the depth estimation method, in accordance with an embodiment of the present disclosure.

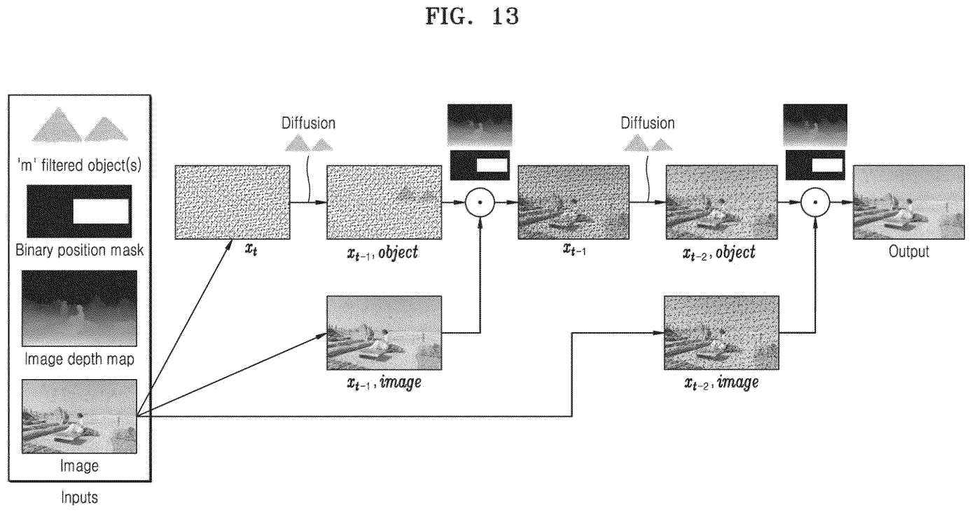

FIG. 12H illustrates a plurality of examples for the ScaleRef Network in the depth estimation method, in accordance with an embodiment of the present disclosure. FIG. 13 illustrates an operation of an object image synthesizer of the system 204, in accordance with an embodiment of the present disclosure.

In order to seamlessly generate and place objects in the image, the processor 304 may use DACAOG process 400. The DACAOG process 400 may use at least three inter-dependent components which include, but are not limited to, a doodle stroke-based object generation method, a contrastive scene-object-position mapping model, and a relative depth estimation method/module.

The doodle stroke-based object generation method may be used to generate objects with assistance from color and size strokes provided by the user. In some embodiments, where a plurality of objects is predicted by doodle strokes, the plurality of objects is filtered and classified based on parameters such as, but not limited to, context of the scene, depth, and position at which the generated object has to be added.

At step 402, the processor 304 may receive an input image (referred to here as the image) which requires assisted object generation. At step 404, the detecting module 314 may be configured to detect a stroke input indicating a request to insert one or more objects in the image. In an embodiment, the input may be provided by a user. In such an embodiment, the user utilizes the doodle stroke operation on the input image to draw and indicate the object that should to be generated.

At step 406 and at step 407, the detecting module 314 may be configured to detect the doodle strokes 504 from the stroke input as done by the user, as shown in block 502, for object generation. In such an embodiment, referring to FIG. 5, the extracting module 320 may be configured to extract the doodle strokes 504 from the stroke input. In an embodiment, the extracting module 320 may be a doodle strokes extraction module. For instance, the doodle strokes 504 may be drawn with a custom color and size-based strokes on top of the image. The doodle strokes 504 may be drawn on a canvas layer overlaid on top of the image. Each drawn doodle stroke may be saved as an image. When the user draws multiple doodle strokes, each doodle stroke image may be merged on a blank canvas of the same size as the image. This canvas containing the merged doodle strokes may be saved as an independent “doodle stroke image”. The system 204 necessitates the user to draw the strokes on the image, to provide spatial information pertaining to the object generation and placement in the image to the system 204. The presence of the extraction module 320 enables the extraction of the doodle strokes 504 from the image to enable the system 204 to capture both the spatial and appearance characteristics of the object to be generated in the input image.

Further, the determining module 316 may be configured to determine a shape and a color of the stroke input, i.e., the doodle strokes 504.

At step 408, the doodle stroke-based object generation process may be implemented in order to predict the plurality of objects that correspond to the stroke input provided by the user. In an embodiment, the generating module 318 may be configured to generate, using an AI model, a plurality of first candidate objects (p) based on the determined shape and color of the stroke input. At step 410, the plurality of the first candidate objects (p) is generated adhering to the color and shape of strokes. In such an embodiment, the extracting module 320 may be configured to extract, using a low-pass filter, color-based features of the detected stroke input. The generating module 318 may be configured to generate a color feature map corresponding to the stroke input based on the extracted color-based features and one or more predefined color-related parameters. Further, the extracting module 320 may be configured to extract, using a high-pass filter, shape-based features of the detected stroke input. The generating module 318 may be configured to generate a shape feature map corresponding to the stroke input based on the extracted shape-based features and one or more pre-defined shape-related parameters. Further, the generating module 318 may be configured to generate, using a diffusion mode, the first plurality of candidate objects based at least on the generated color feature map, the generated shape feature map, and a plurality of random noises.

With reference to FIG. 6, particularly, the doodle stroke-based object generation process may be used to generate the plurality of first candidate objects (p) based on the color and size of the doodle stroke 504, explained in later paragraphs. The process 600 describes the doodle-to-object diffusion model in detail. At step 602, the process 600 takes a random noise image and the doodle stroke 504 as inputs. At step 604, the input acquired at step 602 is shared with a U-net-based diffusion model. The U-net-based diffusion model learns to generate the required object by minimizing color-guided loss and stroke-guided loss explained in later paragraphs. The stroke-guided loss and color-guided loss are cosine similarity loss between doodle strokes 504 and a ground truth object image. The U-Net-based diffusion model is trained to generate the plurality of first candidate object (p) from the noise image and doodle strokes 504 by reversing the noising process. This training process is called a reverse diffusion process. This process involves minimizing stroke-guided loss and color-guided loss, which evaluates how effectively the model can transform noise samples into objects that closely resemble the doodle strokes 504.

In an embodiment, for the stroke-guided loss, with reference to FIG. 7, the stroke-guided loss is generated due to the utilization of the doodle-to-object diffusion model. Method 700 is used for the calculation of the stroke-guided loss. At step 702, the stroke input is provided by the user to generate the doodle stroke 504. At step 704, the doodle stroke 504 is passed through a stroke encoder for further processing, whereas at step 706, stroke embeddings are obtained. In an embodiment, the stroke encoder may include a series of convolution layers that encode the doodle strokes 504 into a representation that captures stroke features.

Further, at step 708, the doodle stroke 504 is used to generate at least one of the plurality of first candidate objects (p) using the doodle-to-object diffusion model. At step 710, the generated at least one of the plurality of first candidate objects (p) is obtained from the doodle-to-object diffusion model. At step 712, the generated at least one of the plurality of first candidate objects (p) is passed through an image encoder to further obtain image embeddings at step 714. The stroke encoder and the image encoder are trained in a contrastive fashion such that correct stroke and image pairs have similar representations, have similar representations in the latent space and un-related stroke and image pairs have far separated latent representations. A cosine similarity-based loss method is used to train the stroke encoder and the image encoders, wherein cosine similarity is maximized from stroke and image pairs, and cosine similarity is minimized for distinctive stroke and image pairs.

$${Cosine}_{Similarity} = \frac{A \cdot B}{‖ A ‖ \cdot ‖ B ‖} = \frac{{\sum }_{i = 1}^{n} {A}_{i} {B}_{i}}{\sqrt{{\sum }_{i = 1}^{n} {A}_{i}^{2} .} \sqrt{{\sum }_{i = 1}^{n} {B}_{i}^{2} .}} \qquad ( Formula 1 )$$

Where Aᵢ and Bᵢ are embeddings from stroke encoders and image encoders respectively.

With reference to FIG. 8, the color-guided loss is generated due to the utilization of the doodle-to-object diffusion model diffusion model. A method 800 is used for the calculation of color-guided loss. At step 802, the doodle strokes 504 is provided for the generation of the plurality of first candidate objects (p). At step 804, the doodle strokes 504 is linearized in order to obtain a linear stroke image. At step 806, the doodle strokes 504 is binarized in order to obtain a binary stroke image. In an embodiment, binarization refers to the conversion of a Red, Green, and Blue (RGB) image into a bi-level image. Each image pixel is separated into a dual collection of pixels i.e. black and white. The main goal of binarization is a segmentation of the image into foreground and background. At step 808, the doodle-to-object diffusion model is used on the doodle strokes 504, and at step 810, the at least one of the plurality of first candidate objects (p) is generated. Further, at step 812, the generated at least one of the plurality of first candidate objects (p) is element-wise multiplied with binary stroke image in order to obtain masked generated at least one of the plurality of first candidate objects (p). The masked generated at least one of the plurality of first candidate objects (p) ensures the guidance is localized in the stroke region and does not affect other regions. At step 814, the generated at least one of the plurality of first candidate objects (p) is linearized in order to obtain a linear masked generated image. In an embodiment, linearized refers to the conversion of an red, green, blue (RGB) channel image to a single dimension vector.

At step 816, the color similarity loss is determined in order to minimize the similarity between the linear stroke image and the linear masked generated image.

$${Color}_{\cdot Similarity} = \frac{A \cdot B}{‖ A ‖ \cdot ‖ B ‖} = \frac{{\sum }_{i = 1}^{n} {A}_{i} {B}_{i}}{\sqrt{{\sum }_{i = 1}^{n} {A}_{i}^{2} .} \sqrt{{\sum }_{i = 1}^{n} {B}_{i}^{2} .}} \qquad ( Formula 2 )$$

Wherein, A and B are linear stroke images and linear masked generated images respectively. This configuration ensures a similarity-based loss to match the color of the doodle strokes 504 with a color of the predicted image.

At step 606, the doodle stroke 504 is shared with the color and shape transfusion module. The color and shape transfusion module is designed using a multi-scale convolutional neural network, which extracts the color and shape features from the doodle stroke 504 and combines with the U-net-based diffusion model at each diffusion time step to finally generate the plurality of first candidate objects (p).

In an embodiment, the color and shape transfusion module functions by extracting the color and shape features from doodle strokes and fusing them with each stage of the reverse diffusion process to guide object generation. The color and shape transfusion module includes two convolutional-based encoder-decoder networks that try to obtain the low-frequency and high-frequency features respectively from the doodle strokes 504. Low-frequency features such as color features are obtained from the doodle strokes 504 by using a low-pass filter, whereas high-frequency features such as edge maps are obtained by using a high-pass filter. Color and shape features extracted are transfused into the diffusion block of the Object-to-Doodle model at each time step.

Referring to FIG. 9, the color and shape features may be extracted by a color extractor and a shape extractor. The color extractor may be trained by performing the following operations:
Create ground truth (GT) Images from Stroke images using a low pass filter.
Set the kernel dimension to a high value to get low-level features.
Train the color extractor network in a supervised way using mean squared error (MSE) loss.

Similarly, the shape extractor may be trained by performing the following operations:
Create GT Images from Stroke images using a high pass filter.
Set the kernel dimension to a low value to get high-level features
Train the shape Extractor network in a supervised way using MSE loss

This process ensures that the color features of the plurality of generated first candidate objects may be based on the colors of the user-drawn strokes. This process also ensures that the doodle strokes 504 with different sizes may have different weightage of color in the plurality of generated objects. For example, thicker strokes may have more color influence on the plurality of generated objects compared to thinner strokes. This process receives user-drawn strokes from the doodle stroke 504, generates random noise internally, and passes both the data to the Doodle-to-Object diffusion model to generate the plurality of first candidate objects (p).

In an embodiment, the identifying module 322 may be configured to identify a location of the stroke input within the image. In such an embodiment, the determining module 316 may be configured to determine a size of the detected stroke input. The identifying module 322 may be configured to identify a bounded region within the image based on the determined size of the stroke input. The identifying module 322 may be configured to identify the location of the stroke input within the image based on the identified bounded region.

Particularly, at steps 411 and 412, the doodle stroke input image created at step 404 is utilized for stroke region computation by a stroke region computation module. At step 414, after determination of the stroke region, a binary position information is generated to process the region of placement of the generated object. In such embodiment, the stroke region computation refers to a computation of the position and region spanned by the doodle strokes 504 drawn by the user on top of the image. This helps to identify the position at which at least one of one or more selected second-candidate objects may be placed. Based on the bounding region, the generating module 318 may be configured to generate a binary mask which helps in blending objects seamlessly into images. Particularly, to fetch the binary position information or to create stroke region-based binary mask, the determining module 316 may be configured to determine the bounding region, for example, a bounding rectangle, from the doodle strokes 504. This binary mask acts as a localization condition to help an object image synthesizer to place the generated object properly. Thus, the placing module 328 may be configured to place the at least one of one or more selected second candidate objects based on the generated binary mask and determined depth information. In an embodiment, selection of the one or more second candidate objects and the determination of the depth information is explained in later paragraphs.

To determine the bounding region spanned by the doodle strokes 504, referring to FIG. 10, the following operations 1000 are performed:

The detecting module 314 may be configured to detect the doodle strokes 504 from the stroke input as shown in step 1002.

The identifying module 322 may be configured to identify a left point, a top point, a right point, and a bottom point of the doodle strokes 504 as shown in step 1004. These points define the left, top, right, and bottom edges of the region of the doodle strokes 504.

The determining module 316 may be configured to determine the bounding rectangle based on the identified points as shown at step 1006. This rectangle represents the region spanned by the doodle strokes 504.

The binary mask is obtained based on a rectangle from previous step where white pixels represent stroke drawn region and black pixels represent background region as shown at step 1008.

Further, the identifying module 318 may be configured to identify a context of a scene of the image.

In an embodiment, after identifying the location and identified context of the scene, the selecting module 324 may be configured to select the one or more second candidate objects among the plurality of first candidate objects based on the identified context of the scene and the identified location of the stroke input. In such an embodiment, the determining module 316 may be configured to determine a correlation score associated with each of the plurality of first candidate objects based on identified context of the scene and the identified location of the stroke input. The selecting module 324 may be configured to select the one or more selected second-candidate objects among the plurality of first-candidate objects based on the determined corresponding correlation scores.

Referring to FIGS. 4 and 11A, at step 416, after the determination of the stroke region, the output is shared with a contrastive scene-object-position mapping model 1102, which also acquires respective output from step 410, containing the plurality of first candidate objects (p), and from step 402, which is the image. At step 418, the information acquired at step 416 is processed and top correlated objects (N), i.e., one or more second candidate objects (N) from step 410 are selected.

In an embodiment, the contrastive scene-object-position module 1102, includes a pre-trained contrastive model configured to learn the mapping between the image, the object to be generated in the image, and the position of the object where it is placed. The position base information is encoded along with the image and is fed to the contrastive pre-trained scene-object-position mapping model. This method tries to learn the relation of an object with the whole image at a predefined position. This model is trained in a contrastive manner such that an object that has a high probability of being present in the image has a higher correlation score and an object whose probability of being in the image at a particular position is less will have a low correlation score. For example, a ‘pizza’ will have a high correlation to a plate image compared to a landscape scenery image, whereas a mountain will have the high correlation to a landscape scene compared to an image containing a culinary plate. Position also plays an important role in determining correlation scores. An object should make sense of being present at a particular location.

Referring to FIG. 11B, the contrastive scene-object-position mapping model 1102 is a pre-trained model that is adapted to learn the mapping between the image scene and object to be generated, and the position of the object in the scene. The position base information is encoded along with the image and is fed to the contrastive pre-trained scene-object-position mapping model. The method 1100 is designed to learn a relation between a selected object with the scene in the image at a predefined location. Initially, a natural image from the dataset is selected and then an object is selected where the object that is associated with the selected image along with the position information. At step 1104, a triple dataset comprising a natural image (I), object (O) associated with the natural image (I), and position information (P) is assumed, which is represented with bounding co-ordinates on the object (O). At step 1106, an object pool is created by using the images present at step 1110.

At step 1108, the objects (O) are passed through an object encoder. At step 1110, an image pool is created by using the triplet dataset created at step 1104. At step 1112, the images (I) are passed through an image encoder, and the position information (P) is appended to image encodings and is passed through the network. This model jointly trains the image encoder and the object encoder to predict the correct pairings of images and objects. In an embodiment, the image encoder and the object encoder are a series of convolutional layers that extract different levels of features from the input image/object. Each layer applies a set of filters to the image and outputs a feature map that highlights specific patterns and structures in the image/object. These specific pattern features are then linearized and a mapping score is obtained between any image or object set.

At step 1114, the contrastive scene-object-position mapping model learns to recognize the association of object (O) with respect to position (P) and visual concept of the image (I). The contrastive scene-object-position mapping model is trained in the contrastive fashion wherein the object similarity with respect to position and context of the image is maximized for correct pairs of image-object-position and similarity is minimized for incorrect pairs.

Further, the contrastive image-object-position mapping model 1102, while training, requires correct pairings of images and objects along with position information. Therefore, a dataset may be formed that contains a pool of images and associated objects. The pool of images is formed such that each image can have one or more associated objects which when placed at a particular position in the image, generate another meaningful image. For example, referring to FIG. 11C, (i), a pyramid object may be placed in the scene (input image). Further, in (ii), a pizza object may be placed on a plate (input image).

The contrastive scene-object-position mapping model has been discussed in FIGS. 11A-11C and will now be explained in reference to FIG. 11D. The contrastive scene-object-position mapping model may have multiple possible outputs, such that there can be more than one object corresponding correlation to a given image (I) at a given position (P). Further, there can be multiple outputs selected by the contrastive scene-object-position mapping model, wherein, both outputs can be sent forward for a depth estimation model and hence the contrastive scene-object-position mapping model can have more than one output. Particularly, referring to FIG. 11D (i) and (ii), the doodle strokes 504 drawn by the user are fed to the doodle stroke-based object generation module, which outputs the plurality of first candidate objects (p). These objects are fed to the contrastive-image-object-position mapping module 1102 along with the image (I) and stroke region bounding rectangle to find an object which has the highest correlation with the image. Further, the stroke region bounding rectangle is obtained from the stroke region computation module based on the position at which the user has drawn doodle strokes on the image. Further, there are multiple possible outputs from this model, i.e. there can be more than one object {O(1 . . . n)} which has a similar correlation to the image (I) at a given position. For case where there are multiple objects selected by the contrastive image-object-position mapping module, both the outputs may be sent forward to the depth estimation module.

In an embodiment, further, the determining module 316 may be configured to determine the depth information of the stroke input based on a position of the detected stroke input and one or more neighboring objects within the image. In such an embodiment, the determining module 316 may be configured to determine a depth information/map based on the image, the one or more selected second candidate objects, the position of the detected stroke input, and the identified bounded region within the image.

The depth estimation method is used to estimate depth at which the stroke input is placed based on the position of the doodle stroke 504 from step 404. The relative depth estimation method is further configured to appropriately select the best object suitable based on the size of the generated plurality of first candidate objects (p) present in the image.

Referring to FIG. 12A, the depth estimation method is used if the plurality of objects are candidates for depth estimation, and the depth estimation method can determine the best of the plurality of objects based on depth relativity. The method begins with the user-drawn strokes in the region where the object is to be placed as shown in (i). Further, if the depth of the generated object has to be changed in a scene, the size/position of the object also tends to change. The object has to be moved behind in the image, and then accordingly size/position of the object has to be changed, but that will directly contradict the size of the doodle drawn by the user as shown in (ii) and (iii). The depth information of the stroke input may be determined based on the region at which the doodle strokes are drawn, and the best object candidate can also be determined that best fits to be placed on the image at a given depth as shown in (iv).

Particularly, at step 420, the image received at step 402, the stroke input, and the one or more selected second candidate objects at step 418 are analyzed using a relative depth estimation method. At step 422, the output produced by the relative depth estimation method at step 420 is used for determining M depth maps. At step 424, the objects shared by the relative depth estimation method are filtered.

In an embodiment, to generate the depth information, the following operations are to be followed:
a. Obtain a depth map for the image.
b. Determine the depth of the stroke input based on the bounding box of doodle stroke.
c. Identify a reference object in the image based on the class similarity and proximity to the bounding box of doodle stroke or in case of the absence of a reference object, generate the stroke object as is.
d. If a reference object is present, filter the generated objects based on a comparison of depth, and size of the reference object and generated object.
e. Return the depth map for one or more filtered objects.

In such an embodiment, referring to FIG. 12B, after determining the depth information and the bounding region as shown at block 1202 and 1204, at block 1206, the bounding region may be placed on the determined depth information. At block 1208, the determining module 316 may be configured to determine D_{Gen}. The D_{Gen} may be determined where a bottom edge of the bounding region may overlap pixels of the depth information. Further, simultaneously, the determining module 316 may be configured to determine the M depth maps as shown at block 1210.

Further, as shown at blocks 1212, and 1214, the determining module 316 may be configured to determine a scale based on the D_{Gen}, and the determined scale is transferred to a scale comparison module as shown at block 1216. Further, as shown at blocks 1218, 1220, 1222, and 1224, the determining module 316 may be configured to determine a list of scales for the selected one or more second candidates. Further, the list of scales is transferred to the scale comparison module as shown at block 1216. Lastly, the scale comparison module after receiving the above-mentioned inputs generates the M-filtered objects as shown at block 1226.

In an embodiment, the relative depth method includes a stroke position-based object depth estimation module, and a depth-based object selection module.

Referring to FIG. 12B, blocks 1202 to 1210 illustrate the stroke position-based object depth estimation module in the relative depth estimation method used to determine the depth of the stroke input based on the position of the user-drawn stroke. Additionally, by filtering the generated objects based on its depth-size and the depth-size of a reference object in the image, the depth map for the image is obtained. The image is passed through the relative depth estimation module, for example, Midas to obtain the depth map. The depth of generated objects is determined based on the bounding box/bounding region of the doodle strokes, which is positioned on the obtained depth map. Further, the pixels of the obtained depth map of the image which are overlapping with the bottom edge of the bounding box of stroke define the depth at which the object needs to be placed as D_{Gen}.

Further, referring to FIG. 12C, the reference object in the image is determined based on the class similarity and proximity to the bounding box of doodle stroke Oᵣ. In case of the absence of the reference object, the stroke object is generated as in an original form of the stroke object. In case the reference object is present, the generated objects are filtered based on a comparison of the depth-size of the reference object and generated object. The depth map is returned for one or more filtered objects, thus finally generating the object as per the user requirements.

Further, the depth-based object selection module is based on a plurality of factors, i.e., i) based on the stroke input received as the doodle strokes in the image at the position where the original object has to be generated, ii) the depth of the stroke input in a scene has to be changed, then the size/position of the object also tends to change. The depth of the object can be estimated using the scene depth map. The scene image is passed through the depth estimation model to obtain the depth map. The bounding box obtained from the strokes drawn by the user is placed on the obtained depth map. The pixels of the depth map of the image which overlap with the bottom edge of the bounding box of stroke define the depth at which the object needs to be placed.

Further, based on the image depth map, the depth of the stroke input, and considering the plurality of factors, this module identifies the best candidate object that can be placed on the image. Further, a scale of ratio(Scale_{Comp}) of depth differences and size differences of reference and the stroke input is calculated where depth of the stroke input is obtained from the ‘Stroke Position based Object Depth estimation module’ and the depth of the reference object is calculated from the image depth map. Scale_{Comp} is compared with Scale_{Pred} obtained from ScaleRef network to select right object.

This module defines a set of equations that determine the scale ratio of the object to be placed at the position defined by the stroke region computation rectangle. This scale, i.e., (Scale_{Comp}) is determined based on depth differences and size differences of reference and the stroke input:
Let D_{Ref} be the depth of reference object Oᵣ
Let D_{Gen} be the depth of generated object Q_{g}
Let \hat{p} be ratio of depths of O_{g} and Oᵣ
Let Size(O_{G}) be the height of bounding box of generated object
Let Size(O_{R}) be the height of bounding box of reference object

$$β = {D}_{Ref} / {D}_{Gen}$$

Let Scale_{Pred} denote scale of absolute size of O_{g} wrt absolute size of Oᵣ obtained using ScaleRefNet.

Let Scale_{Comp} denote scale of size of O_{g} wrt size of Oᵣ obtained using following equation:

$${Scale}_{Comp} = \frac{Size ( {O}_{G} ) / Size ( {O}_{R} )}{β} ,$$

The generated objects will look realistic if and only if, Scale_{Comp}=Scale_{Pred}.

The generated objects will be filtered out based on the criterion:

$${Scale}_{Comp} = {Scale}_{Pred} . \qquad ( Formula 3 )$$

Further, the generation of the depth information/map may include but is not limited to, i) same depth, same size object, ii) same depth, small size object, iii) same depth, multiple small sized object which is explained in subsequent paragraphs:
i) same depth, same size object: Referring to FIG. 12D, when the doodle strokes 504 are of the same size as the reference object, and the depth information/map of the stroke input obtained from the stroke position based object depth estimation module is same as depth information/map of the reference object. In this case, the ratio of depths and the ratio of sizes of reference and the stroke input is 1. Hence the object(s) whose scale from ScaleRefNet is 1 is selected and passed further for addition to the image. The same depth, same size object may be determined as:

$${D}_{Ref} = {D}_{Gen} \qquad ( Formula 4 )$$

$$So , \hat{p} = 1$$

$$Size ( {O}_{G} ) = Size ( {O}_{R} )$$

$${Scale}_{Comp} = 1.$$

$$So , object with {Scale}_{Pred} ≅ 1 is selected$$

ii) same depth, small size object: Referring to FIG. 12E, when the doodle strokes 504 are of the smaller size compared to the reference object, and the depth information/map of the stroke input obtained from the stroke position-based object depth estimation module is the same as depth of reference object. In this case, the ratio of depths of reference and the stroke input is 1, and ratio of sizes of reference and the stroke input is 0.5. So, as per algorithm, Scale_{Comp} will be 0.5. Hence the object(s) whose scale from ScaleRefNet is 0.5 is selected. The same depth, small size object may be determined as:

$${D}_{Ref} = {D}_{Gen} \qquad ( Formula 5 )$$

$$So , \hat{p} = 1$$

$$Size ( {O}_{G} ) / Size ( {O}_{R} ) = 0.5$$

$${Scale}_{Comp} = 0.5$$

$$So , object with {Scale}_{Pred} ≅ 0.5 is selected$$

iii) same depth, multiple small sized object: Referring to FIG. 12F, when the doodle strokes 504 are of the smaller size compared to the reference object, and the depth information/map of the stroke input obtained from the stroke position-based object depth estimation module is same as depth of the reference object. In this case, ratio of depths of reference and the stroke input is 1, and ratio of sizes of reference and the stroke input is 0.5. So, as per algorithm, Scale_{Comp} will be 0.5. Hence the object(s) whose scale from ScaleRefNet is 0.5 is selected and passed further for addition to an image. In this particular case, there is more than one object whose scales is 0.5 from ScaleRefNet, hence more than one object will be passed further and there can be more than one output of whole Doodle Assisted Context Aware Object Generation method. The same depth, multiple small sized object may be determined as:

$${D}_{Ref} = {D}_{Gen} \qquad ( Formula 6 )$$

$$So , \hat{p} = 1$$

$$Size ( {O}_{G} ) / Size ( {O}_{R} ) = 0.5$$

$${Scale}_{Comp} = 0.5$$

$$So , object with {Scale}_{Pred} ≅ 0.5 is selected$$

In an embodiment, referring to FIG. 12G, the ScaleRef Network is used to determine the scale of the reference object with respect to the stroke input. The scale value represents the ratio of size of reference object, and the plurality of first candidate objects (p) generated from the doodle stroke when kept at the same depth level. ScaleRef network follows regression network architecture designed based on a convolutional neural network. The training data is prepared by annotating the object-scale of one object with respect to another object. Further, the range description of the scale value may be given as:

$$Scale Valuse > 1 , if Size ( {O}_{Gen} ) < Size ( {O}_{Ref )} \qquad ( Formula 7 )$$

$$Scale Valuse = 1 , if Size ( {O}_{Gen} ) < Size ( {O}_{Ref )}$$

$$Scale Valuse < 1 , if Size ( {O}_{Gen} ) > Size ( {O}_{Ref )}$$

Referring to FIG. 12H, a plurality of examples for the ScaleRef Network may be shown. As shown at (i), the scale value of the reference object with respect to the plurality of first candidate objects (p) generated from the doodle stroke may be 2.1. As shown at (ii), the scale value of the reference object with respect to the plurality of first candidate objects (p) generated from the doodle stroke may be 0.7. As shown at (iii), the scale value of the reference object with respect to the plurality of first candidate objects (p) generated from the doodle stroke may be 0.5. Lastly, as shown at (iv), the scale value of the reference object with respect to the plurality of first candidate objects (p) generated from the doodle stroke may be 200.

Further, at step 426, the filtered objects from step 424, the output produced by M depth maps at step 422, the binary position information shared at step 414, and the image at step 402 are shared with an object image synthesizer, which using the aforementioned inputs synthesizes the final output image at step 428. The object image synthesizer employs a mask-based blended diffusion technique by leveraging and combining the control net model to steer edit towards the local area provided by binary position information with a de-noising diffusion probabilistic model to generate natural-looking results. To seamlessly fuse the final output image with the image background, the object image synthesizer spatially blends noised versions of the image with new object diffusion latent at a progression of noise levels.

In an embodiment, the updating module 326 may be configured to update the image by inserting the at least one of the one or more selected second candidate objects based on the determined depth information and the identified location of the stroke input by the object image synthesizer as shown at FIG. 13 and explained in FIG. 10 and FIG. 12B. Particularly, referring to FIGS. 13 and 12B, the determining module 316 may be configured to determine a depth map of the image based at least on the determined depth information of the at least object and at least one reference object within the image. Further, the determining module 316 may be configured to determine a depth of each of the one or more selected second candidates. The determining module 316 may be configured to determine at least a similarity and a proximity of each of the one or more selected second candidates based on the corresponding depths and the depth map of the image. Further, the filtering module 330 may be configured to filter at least one of the one or more selected second candidate objects based on the determined at least the similarities and the proximities.

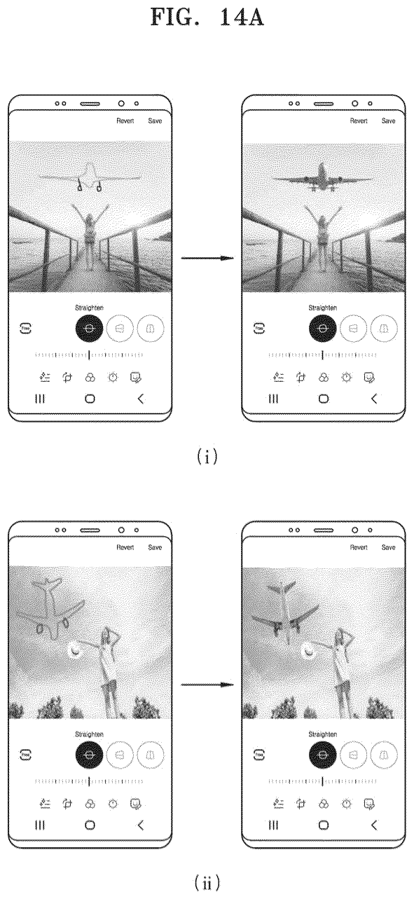

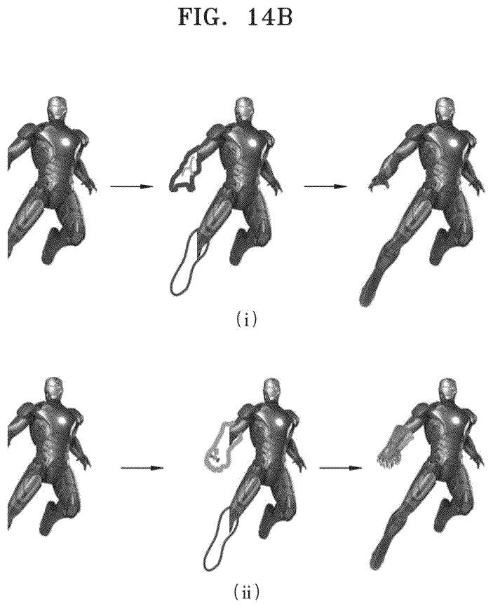

FIGS. 14A-14B illustrate a use case of the system 204, in accordance with an embodiment of the present disclosure.

Referring to FIG. 14A, by applying the processes as explained from FIG. 4 to FIG. 13, the system 204 generates the final output image as required by the user.

Referring to FIG. 14B, by applying the processes as explained from FIG. 4 to FIG. 13, the system 204 generates the complete final output image as required by the user.

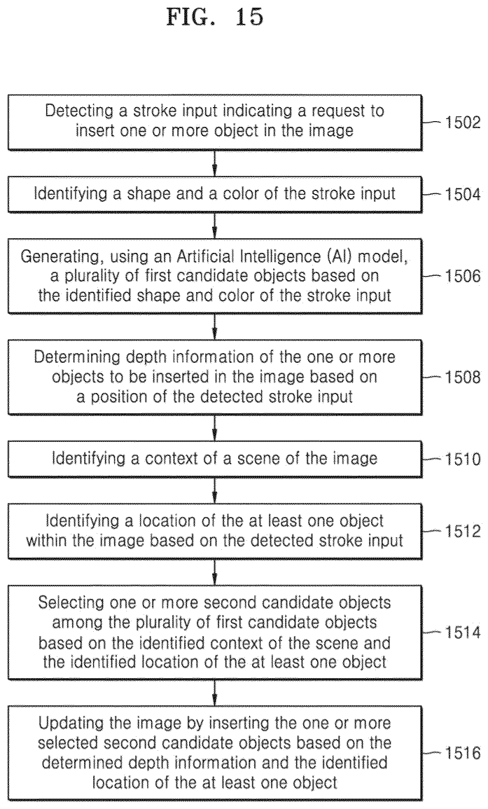

FIG. 15 illustrates a method 1500 performed by the system 204 for the DACAOG, in accordance with an embodiment of the present disclosure.

The method 1500 can be performed by programmed computing devices, for example, based on instructions retrieved from non-transitory computer-readable media. The computer-readable media can include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1500 includes a series of operations shown at step 1502 through step 1516 of FIG. 15. The method 1500 may be performed by the system 204 in conjunction with the modules 312, the details of which are explained in conjunction with FIGS. 3 to 13, and the same are not repeated here for the sake of brevity in the present disclosure. The method 1500 begins at step 1502.

At step 1502, the method 1500 includes detecting the stroke input indicating a request to insert one or more objects in the image.

At step 1504, the method 1500 includes identifying the shape and the color of the stroke input.

At step 1506, the method 1500 includes generating, using the AI model, the plurality of first candidate objects based on the identified shape and color of the stroke input. The method 1500 includes extracting, using the low-pass filter, the color-based features of the detected stroke input. The method 1500 includes generating the color feature map corresponding to the stroke input based on the extracted color-based features and one or more predefined color-related parameters. The method 1500 includes extracting, using the high-pass filter, shape-based features of the detected stroke input. The method 1500 includes generating the shape feature map corresponding to the stroke input based on the extracted shape-based features and one or more predefined shape-related parameters. The method 1500 generates, using the diffusion model, the first plurality of candidate objects based at least on the generated color feature map, the generated shape feature map, the plurality of random noises.

At step 1508, the method 1500 includes determining the depth information of the one or more objects to be inserted in the image based on a position of the detected stroke input and one or more neighboring objects within the image.

In one embodiment, the method 1500 includes determining the depth information of the stroke input based on a position of the detected stroke input and one or more neighboring objects within the image. The method 1500 includes determining the depth map based on the image, the one or more selected second candidate objects, the position of the detected stroke input, and the identified bounded region within the image.

At step 1510, the method 1500 includes identifying the context of the scene of the image.

At step 1512, the method 1500 includes identifying the location of the stroke input within the image based on the detected stroke input. The method 1500 includes determining the size of the stroke input based on the detected stroke input. The method 1500 includes identifying the bounded region within the image based on the determined size of the stroke input. The method 1500 includes identifying the location of the stroke input within the image based on the identified bounded region.

At step 1514, the method 1500 includes selecting the one or more second-candidate objects among the plurality of first candidate objects based on the identified context of the scene and the identified location of the stroke input. The method 1500 includes determining the correlation score associated with each of the plurality of first candidate objects based on the identified context of the scene and the identified location of the stroke input. The method 1500 includes selecting the one or more selected second-candidate objects among the plurality of first-candidate objects based on the determined corresponding correlation scores.

At step 1516, the method 1500 includes updating the image by inserting the one or more selected second candidate objects based on the determined depth information and the identified location of the stroke input. For updating the image, the method 1500 includes generating the binary mask on the image based on the identified bounded region. The method 1500 includes placing the at least one of the one or more selected second candidate objects based on the generated binary mask and determined depth information. Further, updating the image with the at least one of the one or more second candidate objects, the method 1500 includes determining the depth map of the image based at least on the determined depth information of the at least object and at least one reference object within the image. The method 1500 includes determining the depth of each of the one or more selected second candidates. The method 1500 includes determining at least the similarity and the proximity of each of the one or more selected second candidates based on the corresponding depths and the depth map of the image. The method 1500 includes filtering at least one of the one or more selected second-candidate objects based on the determined at least the similarities and the proximities.

The present disclosure presents us with various advantages such as:

The method provides a more controlled way of generating objects in an image.

Defining and localizing objects is done by utilizing a single user input.

Multiple prior derivations can be inferred based on user-drawn strokes and input images provided by the user.

The method can generate object images that are not seen by the model or do not exist in the real world.

Particularly, the doodle stroke-based object generation engine effectively overcomes the problems mentioned in the existing art as the object generation is closely guided by user-provided colored strokes provided by use. This engine is designed such that object generation strictly follows appearance properties defined by the shape, color, and size of doodle strokes and remains unaffected by any other content or artifact in the image.

The contrastive image-object-position mapping module has the ability to estimate if any object at a given position in the image is suitable or not. This ability can be used by any image generation model to identify if a generated image makes appropriate sense by analyzing objects in the image. This engine is used to restrict generative AI models from generating immodest/foul objects in images, unlike existing art, by detecting each object in an image and identifying if any object is foul or is placed wrongly by understanding the context of the image. This engine also suggests appropriate objects that can replace any foul object present in an image.

Further, the depth estimation module/method provides the ability to estimate and control the depth at which an object can be placed. This module identifies the depth at which an object can be placed, but also can suggest if the object to be placed is suitable in the image unlike as the existing art.

While at least one exemplary embodiment has been presented in the foregoing detailed description, it should be appreciated that a vast number of variations exist.

Herein, a computer-readable non-transitory storage medium or media may include one or more semiconductor-based or other integrated circuits (ICs) (such, as for example, FPGAs or ASICs), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method for object insertion in an image, the method comprising:
detecting a stroke input indicating a request to insert one or more objects in the image;
identifying a shape and a color of the stroke input;
generating, using an artificial intelligence (AI) model, a plurality of first candidate objects based on the shape and the color of the stroke input;
determining depth information of the one or more objects to be inserted in the image based on a position of the stroke input and one or more neighboring objects within the image;
identifying a context of a scene of the image;
identifying a location of the stroke input within the image;
selecting one or more second candidate objects among the plurality of first candidate objects based on the context of the scene and the location of the stroke input; and
updating the image by inserting the one or more second candidate objects based on the depth information and the location of the stroke input.

2. The method as claimed in claim 1, wherein the identifying the location of the stroke input within the image comprises:
identifying a size of the stroke input;
identifying a bounded region within the image based on the size of the stroke input; and
identifying the location of the stroke input within the image based on the bounded region.

3. The method as claimed in claim 2, wherein the determining the depth information of the one or more objects to be inserted in the image comprises:
determining a depth map based on the image, and
determining the position of the stroke input.

4. The method as claimed in claim 3, wherein the updating the image comprises:
generating a binary mask of the image based on the bounded region; and
inserting at least one of the one or more second candidate objects based on the binary mask and depth information.

5. The method as claimed in claim 1, wherein the generating the plurality of first candidate objects comprises:
extracting, using a low-pass filter, color-based features of the stroke input;
generating a color feature map corresponding to the stroke input based on the color-based features and one or more predefined color-related parameters;
extracting, using a high-pass filter, shape-based features of the stroke input;
generating a shape feature map corresponding to the stroke input based on the shape-based features and one or more predefined shape-related parameters; and
generating, using a diffusion model, the plurality of first candidate objects based at least on the color feature map, the shape feature map, and a plurality of random noises.

6. The method as claimed in claim 1, wherein the selecting the one or more second candidate objects among the plurality of first candidate objects comprises:
determining correlation scores associated with the plurality of first candidate objects based on the context of the scene and the location of the stroke input; and
selecting the one or more second candidate objects among the plurality of first candidate objects based on the correlation scores.

7. The method as claimed in claim 1, wherein the updating the image with the one or more second candidate objects comprises:
determining a depth map of the image based at least on the depth information of the one or more objects to be inserted in the image and at least one reference object within the image;
determining a depth of each of the one or more second candidate objects;
determining a similarity and a proximity of each of the one or more second candidate objects based on the depth of each of the one or more second candidate objects and the depth map of the image; and
filtering at least one of the one or more second candidate objects based on the similarity and the proximity of each of the one or more second candidate objects.

8. A device for object insertion in an image, the device comprising:
a memory configured to store at least one instruction; and
at least one processor operatively coupled with the memory, wherein the at least one instruction, when executed by the at least one processor individually or collectively, causes the device to:
detect a stroke input indicating a request to insert one or more object in the image;
identify a shape and a color of the stroke input;
generate, using an artificial intelligence (AI) model, a plurality of first candidate objects based on the shape and the color of the stroke input;
determine depth information of the one or more objects to be inserted in the image based on a position of the stroke input and one or more neighboring objects within the image;
identify a context of a scene of the image;
identify a location of the stroke input within the image;
select one or more second candidate objects among the plurality of first candidate objects based on the context of the scene and the location of the stroke input; and
update image by inserting the one or more second candidate objects based on the depth information and the location of the stroke input.

9. The device as claimed in claim 8, wherein the at least one instruction, when executed by the at least one processor individually or collectively, causes the device to identify the location of the stroke input within the image by:
identifying a size of the stroke input;
identifying a bounded region within the image based on the size of the stroke input; and
identifying the location of the stroke input within the image based on the bounded region.

10. The device as claimed in claim 9, wherein the at least one instruction, when executed by the at least one processor individually or collectively, causes the device to determine the depth information of the one or more objects to be inserted in the image by:
determining a depth map based on the image, and
determining the position of the stroke input.

11. The device as claimed in claim 10, wherein the at least one instruction, when executed by the at least one processor individually or collectively, causes the device to update the image by:
generating a binary mask on the image based on the bounded region; and
inserting at least one of the one or more second candidate objects based on the binary mask and depth information.

12. The device as claimed in claim 8, wherein the at least one instruction, when executed by the at least one processor individually or collectively, causes the device to generate the plurality of first candidate objects by:
extracting, using a low-pass filter, color-based features of the stroke input;
generating a color feature map corresponding to the stroke input based on the color-based features and one or more predefined color-related parameters;
extracting, using a high-pass filter, shape-based features of the stroke input;
generating a shape feature map corresponding to the stroke input based on the shape-based features and one or more predefined shape-related parameters; and
generating, using a diffusion model, the plurality of first candidate objects based at least on the color feature map, the shape feature map, and a plurality of random noises.

13. The device as claimed in claim 8, wherein the at least one instruction, when executed by the at least one processor individually or collectively, causes the device to select the one or more second candidate objects among the plurality of first candidate objects, the at least one processor by:
determining correlation scores associated with the plurality of first candidate objects based on the context of the scene and the location of the stroke input; and
selecting the one or more second candidate objects among the plurality of first candidate objects based on the correlation scores.

14. The device as claimed in claim 8, wherein the at least one instruction, when executed by the at least one processor individually or collectively, causes the device to update the image with the one or more second candidate objects by:
determining a depth map of the image based at least on the depth information of the one or more objects to be inserted in the image and at least one reference object within the image;
determining a depth of each of the one or more second candidate objects;
determining a similarity and a proximity of each of the one or more second candidate objects based on the depth of each of the one or more second candidate objects and the depth map of the image; and
filtering at least one of the one or more second candidate objects based on the similarity and the proximity of each of the one or more second candidate objects.

15. A non-transitory computer-readable recording medium having recorded thereon instructions executable by at least one processor configured to perform a method for image encoding, the method comprising:
detecting a stroke input indicating a request to insert one or more objects in the image;
identifying a shape and a color of the stroke input;
generating, using an artificial intelligence (AI) model, a plurality of first candidate objects based on the shape and the color of the stroke input;
determining depth information of the one or more objects to be inserted in the image based on a position of the stroke input and one or more neighboring objects within the image;
identifying a context of a scene of the image;
identifying a location of the stroke input within the image;
selecting one or more second candidate objects among the plurality of first candidate objects based on the context of the scene and the location of the stroke input; and
updating the image by inserting the one or more second candidate objects based on the depth information and the location of the stroke input.
